(19) United States
(12) Patent Application Publication
(10) Pub. No.: US 2019/0102163 A1
(43) Pub. Date: Apr. 4, 2019

(54) System and Method for a Blockchain-Supported Programmable Information Management and Data Distribution System

(71) Applicant: Dispatch Labs, LLC, San Francisco, CA (US)

(72) Inventor: John Zane Witherspoon, San Francisco, CA (US)

(73) Assignee: Dispatch Labs, LLC, San Francisco, CA (US)

(21) Appl. No.: 16/152,356

(22) Filed: Oct. 4, 2018

Related U.S. Application Data
(60) Provisional application No. 62/567,762, filed on Oct. 4, 2017.

(51) Int. Cl. G06F 8/65; H04L 9/32; G07C 13/00

(52) U.S. Cl. CPC G06F 8/65; H04L 9/3236; H04L 2209/56; H04L 2209/38; G07C 13/00

(57) ABSTRACT

A system, method, and computer program for a blockchain-supported programmable information management and data distribution system for decentralized application development that integrates scalability power with functional decentralized application development environment and high data storage capacity. The system may comprise a virtual machine that supports and unites on-chain logic capabilities and off-chain data management capabilities. On-chain logic capabilities may comprise application of rate-limiting capabilities, use of currency, and delegated asynchronous proof-of-stake functionality. Off-chain data management capabilities may comprise an artifact network, multi-party protocol, and analytic capabilities. Incorporation of smart contracts may be supported directly by the virtual machine.

### CROSS-REFERENCE TO RELATED APPLICATIONS

This application claims benefit to U.S. Provisional Application No. 62/567,762, filed on Oct. 4, 2017, entitled “Dispatch: A blockchain supported programmable information management and data distribution system”, the contents of which are incorporated by reference herein as though set forth in their entirety, and to which priority and benefit are claimed.

### TECHNICAL FIELD

The present disclosure relates generally to a system, method, and computer program product for an extended development platform and more particularly, to systems and methods for a business-ready, blockchain-supported programmable information management and data distribution system that enables and improves the capabilities of advanced distributed application development.

### BACKGROUND INFORMATION

Blockchain technology functions as a distributed ledger, with every user owning an identical copy of the ledger. Transactions carried out via blockchain technology require transferring, storing, and writing data to blockchains. The increasing size of blockchain data has the effect of slowing down the growth of blockchains and making storage of larger amounts of data impracticable. The continued growth of a ledger will inevitably result in the ledger outgrowing the storage capacity of a typical node within the blockchain. The shrinking number of nodes with the required resources to address costs and growth culminates in recentralization of blockchains. The increasing number of transactions in blockchains combined with diminishing capacities to facilitate them contributes to scalability issues. Scalability is now becoming a prominent issue in existing distributed ledger technologies. Yet current attempts that address scalability issues do so at the expense of other capabilities.

Decentralized applications (Dapps) are open source applications or programs that run on a distributed ledger. Along with scalability capabilities, Dapps require platforms that also provide functional Dapp development environments and the necessary data storage. Yet present-day development protocols offer only one or two of these capabilities. As the future of Dapps begins to emulate the world of centralized applications and its use of data that exceeds the storage capabilities of current blockchain technology, scalability issues will persist.

Thus, what is needed is a decentralized blockchain-supported programmable information management and data distribution system for Dapp development that integrates scalability power with functional Dapp development environment and high data storage capacity. Extending the functionality and scalability of existing blockchain technology to handle and utilize any quantity of data at any scale will drastically increase the potential use cases and adoption of blockchain by both consumers and enterprises.

### SUMMARY OF THE DISCLOSURE

The following presents a simplified overview of the example embodiments in order to provide a basic understanding of some embodiments of the present disclosure. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented herein below. It is to be understood that both the following general description and the following detailed description are exemplary and explanatory only and are not restrictive.

The present disclosure is directed to a system and method for a blockchain-supported programmable information management and data distribution system, the system comprising a processor, memory accessible by the processor, and instructions stored in the memory and executable by the processor to perform: establishing custody of at least one artifact; generating an update to the system, wherein the update to the system is generated by: generating at least one transaction upon the establishing custody of at least one artifact; validating the at least one transaction; accepting the at least one transaction into a ledger; and executing the at least one transaction; transmitting to a virtual machine confirmation of an update of the at least one artifact; and transmitting to a virtual machine confirmation of the executing the at least one transaction.

Still other advantages, embodiments, and features of the subject disclosure will become readily apparent to those of ordinary skill in the art from the following description wherein there is shown and described a preferred embodiment of the present disclosure, simply by way of illustration of one of the best modes best suited to carry out the subject disclosure. As will be realized, the present disclosure is capable of other different embodiments and its several details are capable of modifications in various obvious embodiments all without departing from, or limiting, the scope herein. Accordingly, the drawings and descriptions will be regarded as illustrative in nature and not as restrictive.

### BRIEF DESCRIPTION OF THE DRAWINGS

The accompanying drawings, which are incorporated in and constitute a part of this specification, illustrate embodiments of the disclosure and together with the general description of the disclosure given above and the detailed description of the drawings given below, serve to explain the principles of the disclosure. In certain instances, details that are not necessary for an understanding of the disclosure or that render other details difficult to perceive may have been omitted.

FIG. 1 is a functional flow diagram generally illustrating the flow of an artifact within a blockchain-supported programmable information management and data distribution system.

FIG. 2 is a functional block diagram generally illustrating an embodiment of the architecture for a blockchain-supported programmable information management and data distribution system.

FIG. 3 is a functional flow diagram generally illustrating an embodiment of validating a transaction via a delegated asynchronous proof-of-stake functionality.

FIG. 4 is a functional flow diagram generally illustrating an embodiment of transaction states occurring in a world state.

FIG. 5 is a functional block diagram generally illustrating an embodiment of a network system of a blockchain-supported programmable information management and data distribution system.

FIG. 6 is a functional block diagram generally illustrating an embodiment of an electronic device system of a blockchain-supported programmable information management and data distribution system.

### DETAILED DESCRIPTION OF EMBODIMENTS

Before the present systems and methods are disclosed and described, it is to be understood that the systems and methods are not limited to specific methods, specific components, or to particular implementations. It is also to be understood that the terminology used herein is for the purpose of describing particular embodiments only and is not intended to be limiting. Various embodiments are described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

In one embodiment, the protocol platform may enable individuals to share intellectual property, through the protocol platform, directly to other individuals or entities, such as an artist selling their music. The protocol platform may be compatible with various types of files, such that users may upload art, film, literature, software, virtual reality assets, confidential documents, and other data file types. In another embodiment, video-streaming services could employ the protocol platform for the distribution of their streaming services directly to users. In one embodiment, curriculum management, video or written lessons, and research material distribution may all be stored in the protocol platform. In an educational setting, exams may be administered in the blockchain and grades may be stored immutably. Class workflow may be programmatically configured, such that a student may programmatically unlock access to an additional lesson based on grades previously received.

In another embodiment utilizing the protocol platform, industries requiring storage of large amounts of data may securely store off-chain data. In an embodiment comprising the medical record management industry, medical records may be stored and immutably tracked within the ledger of the protocol platform. Additionally, data stemming from patient assessments and exam results may also be safely stored, tied to a patient via unique node ID, and managed within the ledger.

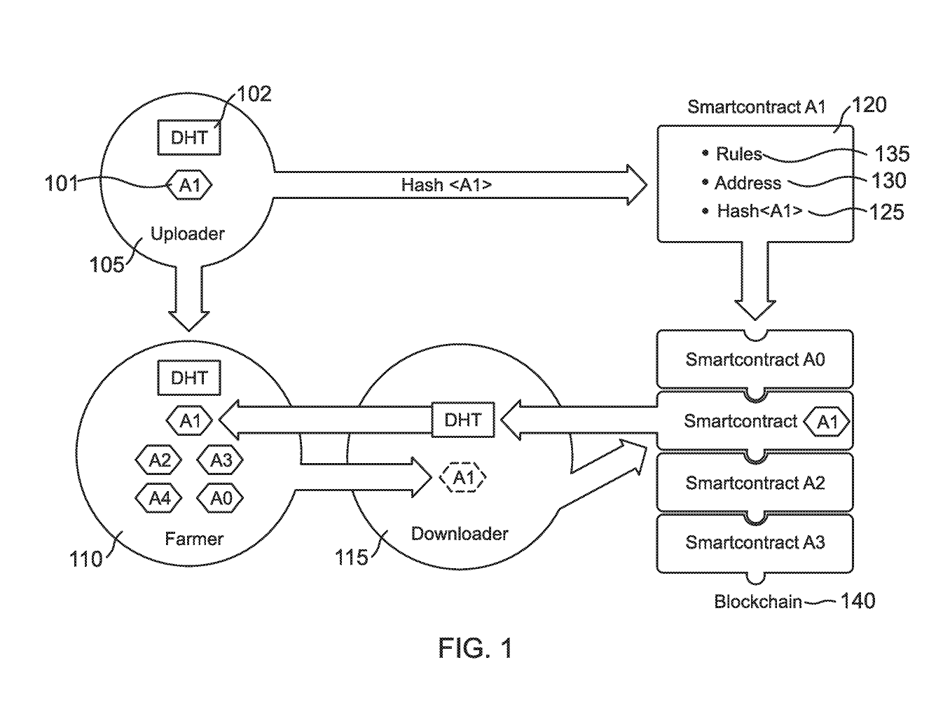

FIG. 1 is a functional flow diagram generally illustrating the flow of an artifact within a blockchain-supported programmable information management and data distribution system (“protocol platform”). In a preferred embodiment, the protocol platform may comprise at least one or more of each of the following: an uploader 105, a farmer 110, and a downloader 115. Every uploader 105, farmer 110, and downloader 115 may be a node within the protocol platform, with each having its own distributed hash table (DHT) 102, identical copy of a shared ledger, and one or more artifacts 101. A DHT 102 may be a hashtable data structure that sits on every node in the protocol platform and may be each node's personal map to navigate a network.

An artifact 101 may be defined as an off-chain data object. An artifact 101 may be a set of data that is written, read, and updated as a single unit. Embodiments of artifacts may comprise a document, movie file, .csv file, virtual reality asset, software program, random hexadecimal string, private key, organized database data, a Merkle tree, or anything else capable of being organized into a replicable data structure. Artifacts 101 may also be defined as the distributed data objects stored in an artifact network. Artifacts stored in an artifact network may be referenced in the ledger by their Merkle hash. Artifacts 101 may be sharded and encrypted for security of private data. Artifacts 101 may also come in two types: structured or as binary large objects. A structured artifact may have several entries with defined properties, similar to rows in a SQL database. A binary large object artifact could be a document, a .csv file, or any other arbitrary data with a defined format. While both artifact types benefit from decentralized algorithms incorporated in an artifact network, structured artifacts may also benefit from analytical tools being applied to it. The governance of each artifact may be defined by its uploader in its associated smart contract. Because a ledger may not be capable of governing what users do with the artifact network data, the distribution of artifacts may be governed outside of a virtual machine.

In one embodiment, the life cycle of a Dapp may commence when an uploader 105 publishes an artifact 101 to the protocol platform. Before publishing, an uploader 105 may create a smart contract 120 that contains a hash 125 of the artifact 101, an address 130 of the artifact 101, and rules 135 for accessing the artifact 101. The smart contract 120 is then published to the blockchain 140, with the publication manifested in a shared ledger. After publication, a downloader 115, such as a user, may request the artifact 101 from the uploader 105. Downloaders 115 may know they have received the artifact requested when the hash of what they received matches the hash in the shared ledger. Uploaders 105 may pay farmers 110 to serve encrypted copies of their artifacts to service more downloaders 115 and to mitigate downtime. Farmers 110 may be compensated for their storage as well as bandwidth. When a downloader 115 wants an artifact, the downloader 115 may use the DHT 102 to find the closest available farmer 110. When downloading an encrypted artifact from a farmer 110, a downloader 115 may still need another version of an encryption key from the uploader 105 responsible for publishing the artifact.

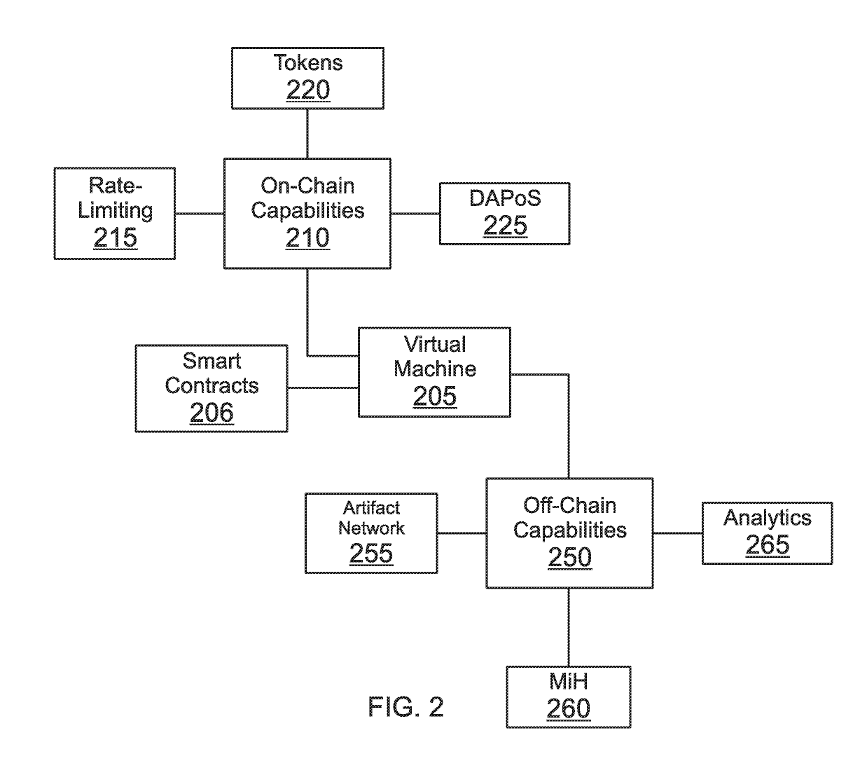

FIG. 2 is a functional block diagram generally illustrating an embodiment of the architecture for a blockchain-supported programmable information management and data distribution system (“protocol platform”). As shown in FIG. 2, a protocol platform may comprise a virtual machine 205 that supports and unites on-chain logic capabilities 210 and off-chain data management capabilities 250. On-chain logic capabilities 210 may comprise application of rate-limiting capabilities 215, use of currency, such as tokens 220, and delegated asynchronous proof-of-stake (DAPoS) functionality 225. Off-chain data management capabilities 250 may comprise an artifact network 255, multi-party protocol (MiH) 260, and analytic capabilities 265. Incorporation of smart contracts 206 may be supported directly by the virtual machine 205.

In an embodiment demonstrating support of on-chain logic capabilities 210, the virtual machine 205 may be a low-level language interpreter for executing smart contracts 206 in the protocol platform. The virtual machine 205 may also support smart contracts 206 so as to allow users to write and execute stateful programs. In an embodiment demonstrating support of off-chain data management capabilities 250, the virtual machine 205 may extend instruction sets to support actions carried out by off-chain management capabilities 250, such as storage and transfer of data.

Smart contracts 206 may function to control the storage of artifacts and access to read and write them. In one embodiment smart contracts 206 may be used to programmatically set access to artifacts based on parameters such as time, price, and user groups. In another embodiment, a user's access to artifacts may be written directly to the contract's state in the shared ledger. Adding programmable access to off-chain artifacts to a programmable shared state's blockchain technology may enable businesses and developers to make Dapps that have not yet been possible in a single framework. Artifacts may be deployed to the artifact network 255 in specialized smart contracts. These artifact network contracts may use specialized functions for accessing and updating the artifact hash and updating the approved access list. Yet smart contracts used in the protocol platform are not required to be artifact exclusive. Dapps that only use stateful data may still be fully compatible with the virtual machine 205.

The protocol platform may also be directed heavily to the storage, transmission, analysis, and manipulation of off-chain artifacts. This may be accomplished by the protocol platform distributing information about the artifacts without sharing the artifacts themselves. In one embodiment, the artifact network 255 may encompass interactions between nodes involving off-chain artifact storage and transmission. Uploaders 105 may seed the artifact network 255 with artifacts or deploy artifacts via smart contract and serve them to downloaders 115. If a file is in such a high demand that an uploader 105 cannot serve all downloaders 115 requesting the file, an uploader 105 may enlist the help of farmers 110 to distribute content. The number and price of farmers 110 enlisted may be decided by an uploader 105, allowing flexibility in balancing affordability and availability. Farmers 110 may play a vital role in the scalability of an artifact network 255. Farmers 110 may deliver artifacts across a network to downloaders 115. Uploaders 105 may typically compensate farmers 110 for their storage, and downloaders 115 may compensate farmers 110 for their bandwidth.

Downloaders 115 may be the most common role in the artifact network 255. Downloaders 255 may receive their artifacts from farmers 110 and uploaders 105. Downloaders 115 typically pay farmers 110 for their bandwidth in transmitting the artifact. If an artifact is encrypted, a downloader 115 may need to get the encryption key from the uploader 105 by telling them which farmer 110 the artifact came from. Once a downloader 115 has the artifact, the downloader 115 may also function as a farmer 110 and serve the artifact to others for a bandwidth reward. Downloaders 115 may find the nearest farmer 110 of an artifact in their own personal DHT 102. DHTs 102 may begin with a single connection and aggregate information from its neighbors to map out where nodes are in the artifact network 255 and to map users' addresses to physical IP addresses. DHTs 102 may watch and search for artifacts in the artifact network 255 with either the artifact address or the node address.

In an embodiment of off-chain operations, scalability solutions implemented by the protocol platform may rely on the capability to trustlessly move off-chain data between nodes in a cryptographically secure manner. As a result, challenges to the community may occur when all nodes have to come to consensus on the result of an interaction between two nodes exchanging information they know nothing about. These types of transactions, between some parties but not all, may be referred to as a set exchange. In an embodiment of a set exchange, a subset of the consensus group, which typically makes up less than the majority, may be trusted by an entire group to report the accurate results of an exchange. In set exchanges, a party may have an incentive to not be honest regarding the results of an exchange. Thus, the protocol platform may implement novel cryptographic solutions that incentivize honesty between trusted parties. Set exchanges between farmers and downloaders may be transacted through a Make it Happen protocol (MiH) 260. Set exchanges between farmers and uploaders may be transacted through a Proof-of-Retrievability protocol (PoR).

In an embodiment of a MiH 260, both participants may store tokens, in escrow, in excess of the actual cost of the transfer. This may be outside the reach of either party, and may last for the duration of the exchange. How the artifact exchange happens or how many attempts it takes then becomes irrelevant. Once the tokens are locked, the rest of the network can only require that the transaction occur. After the artifact exchange is complete, payment is transferred to the farmer and the escrow security deposit is returned to both parties. Because a timed release of the escrow could incentivize one of the parties to act dishonestly, tokens put in a MiH escrow remain there until the transfer occurs. This solution can be fault-tolerant to farmer or downloader downtime and non-malicious features, and downloaders can avoid going into transfers with farmers still in an exchange. In situations where a farmer has lost their copy of the content and has no way of retrieving it, a farmer can release the downloader's tokens and close the MiH exchange by eliminating their own deposit. In this situation, a farmer will lose their staked tokens but also close their open Mill exchange, such that other downloaders will start to offer exchanges for artifacts that they do have available.

In an embodiment, MiH 260 is a protocol for distributing artifacts to downloaders from farmers, wherein not every node is storing every artifact and the system may be required to trust the involved nodes that the transfer actually took place. MiH 260 may incentivize both farmers and downloaders to act honestly in a situation where both parties have an incentive to lie. In an embodiment where a farmer is charging a downloader for bandwidth in a file transfer, both parties may have a reason to not be honest regarding the corresponding transaction. This may lead to either a farmer collecting the downloader's payment without sending the file or the downloader obtaining the file without paying the farmer. MiH 260 may provide trust to the larger consensus group that neither party is dishonest, as dishonesty works against the parties' own self-interest in MiH 260. MiH 260 may also update the world state to include the new downloader of an artifact.

In an embodiment where there are many farmers hosting an artifact, a downloader may go into a multi-party MiH exchange with any number of farmers. The many-to-one nature of the artifact transfer may significantly improve the download times of larger artifacts. And because artifacts are formatted as Merkel trees, the downloader may have complete transparency into both the quality and quantity of data transferred by each farmer; thus being able to compensate them accordingly for their bandwidth.

In an embodiment of a PoR protocol, PoR ensures the availability of an artifact by a farmer. Farmers may be compensated by uploaders for their storage based on duration of a storage agreement. PoR thus may govern the set exchange consensus between farmers and uploaders. Payment to farmers may be withheld until it is proven that farmers have remained in possession of a file for the duration of a storage contract. At the time of contract initialization, a number of PoR challenges may be agreed upon, with the full contract payment being put into escrow and released upon completion of PoR challenges or expiration of the contract. An uploader may challenge a farmer any time during the duration of the contract. Each passed PoR challenge may release coins to the farmer (designated as r), and each failed PoR test may release r coins to the uploader, where r=total storage payment/number of PoR challenges. The farmer then may have an agreed upon number of blocks to respond to the test with a hash of a specific subset of the artifact and a based pseudo-random number. The pseudo-random number may exist so that a farmer cannot hold onto a part or a particular hash of the a shard, demonstrated as: PoR Response=H(Artifact[subset], Pseudorandom number). If no response is provided, the farmer may be presumed offline, a test reward may be returned to the uploader, and a fail-safe redistribution of the artifact may be optionally triggered to a new farmer to ensure availability. Otherwise, the uploader may post their own PoR response. If the hashes match, the farmer passing the test may be given their coins. If the farmer and uploader's hash do not match, neither party may be trusted because both have an economic incentive to lie about what the true hash is. It then becomes the decision of the other owners of the artifact, such as farmers or downloaders, as to which party is telling the truth. In the case of a tie, a reward may go to the uploader.

Analytic capabilities 265 may be defined as analytical queries across any of the structured artifacts distributed in the artifact network 255, without sacrificing data ownership. A data creator may earn rewards for enabling third party access to analytics of their data, without needing to reveal or transfer ownership of any of the underlying data. A data researcher may pay for the extraction of data analytics from a wide variety of data and verify the integrity of the results without ever having to see the data itself. Analytic capabilities 265, including data sovereignty and distributed data analytics, may be powered by a combination of homomorphic findings and proxy re-encryption. By encrypting artifacts stored in the artifact network 255 using a homomorphic encryption scheme, operations may be conducted on the encrypted data to produce an encrypted answer.

The artifact network 255 may handle data distribution differently depending on the actors participating and the governing on-chain rules of the artifact. Agreements between uploaders and farmers may be defined by, and recorded in, a storage orderbook. Farmers may publish storage offers on a ledger, defining three parameters: 1. Maximum available storage capacity, 2. Maximum storage duration, and 3. Minimum cost. When an uploader decides to enlist storage capabilities of a famer, they may accept the storage offer with an artifact Merkle hash (or the Merkle hash of the subset of the artifact the farmer will be responsible for storing), the size of the data they want stored, and the duration. The farmer may then confirm the agreement, and the uploader may send the artifact or shard to the farmer via MiH 260.

The protocol platform may thus be a new blockchain protocol that utilizes the trustless and cryptographically secure exchange of off-chain artifacts to advance the utility of information. Artifact networks 255 may be comprised of a distributed network of farmers 110 plus the storage of various artifacts. These artifacts, (files, datasets, Merkle trees, and more) may be tracked on a shared ledger, while the actual storage and access to read and write those artifacts are controlled via smart contracts. The ledger may run in parallel with the artifact network 255 such that the ledger may track the state and validity of an artifact. Protocol platform participants may earn tokens 220 as elected validators by offering compute to validate the blockchain, as farmers 110 by offering their storage and bandwidth to host and serve artifacts, or a combination of both. Uploaders 105 may use tokens 220 to write to a shared ledger and to pay farmers 110 for storage. Downloaders 115 may use tokens 220 to buy permission to access certain artifacts. While all nodes may maintain a full copy of the shared ledger, every node may keep a different subset of the artifact network 255.

In other embodiments, a node may play several different roles in a blockchain consensus or in the artifact network 255. Roles facilitating consensus among a blockchain may comprise stakeholders, elected witnesses, and elected delegates. No one role need be mutually exclusive, allowing nodes to take on any number roles in various network interactions. A stakeholder may be a node that holds tokens. Stakeholders may be required to elect witnesses and delegates, with one vote per share per candidate in each election. A delegate, or alternatively a witness, may be a node responsible for producing new blocks. In one embodiment, delegates may be elected by stakeholders based on stake-weighted voting. An elected delegate may propose and vote changes to parameters of a network, such as changes to transaction fees, block sizes, witness pay, and block intervals. After a majority of delegates have approved a proposed change, stakeholders have a review period during which they may vote out delegates and modify the proposed change. This may ensure that even in cases of corruption among elected delegates, the strength of the system may still reside in stakeholders.

In one embodiment, DAPoS implements a system of election cycles where stakeholders may elect consensus leaders, allowing for a reduced overhead of replicated work without sacrificing the decentralization of a network. DAPoS may differ when compared to prior art in that its transactions are not grouped into blocks but rather are individually gossiped. Gossip protocols may thus function as an alternative consensus mechanism. Delegates may gossip to achieve even distribution of information before deterministically accepting and validating transactions.

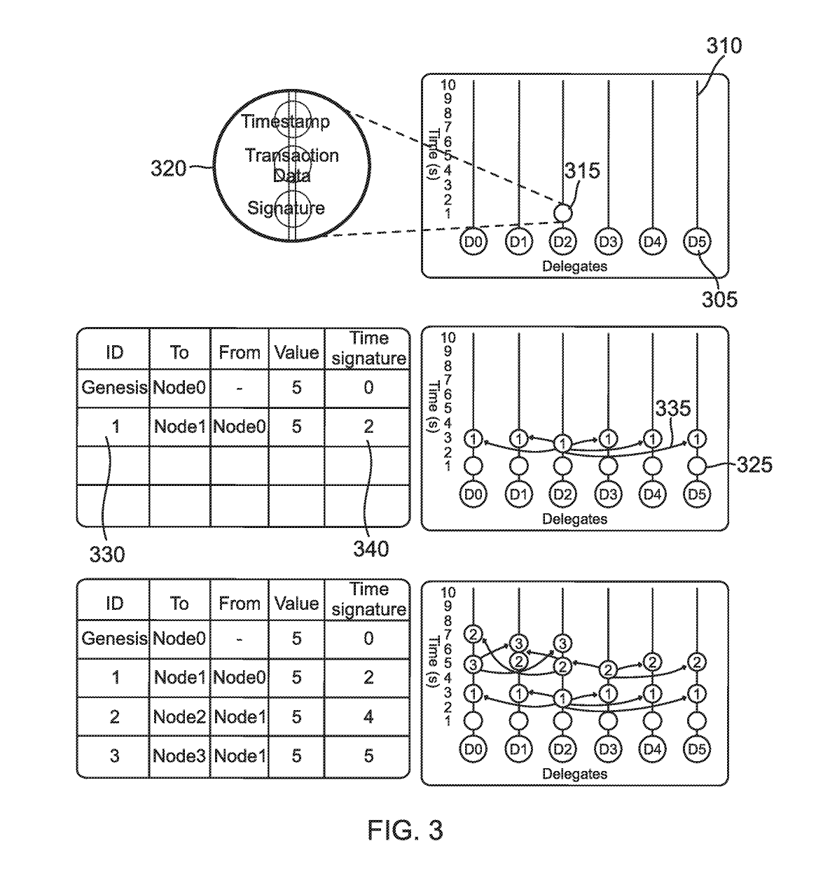

FIG. 3 is a functional flow diagram generally illustrating an embodiment of gossiping a transaction via a delegated asynchronous proof-of-stake functionality (“DAPoS”). As shown in FIG. 3, each delegate 305 may keep track of its own chain 310. Nodes 315 may comprise transactions 320 sent to delegates 305 to be added to their chain 310. Transactions 320 may comprise a timestamp, transaction data, and a signature. All delegates 305 may agree to the initial state 325 of their chains 310. Upon receiving 330 a transaction, delegates may share them 335 if valid or drop them if not valid. Time signatures 340 may be used to prevent double spend attacks. DAPoS functionality may result in some delegates receiving transactions they do not yet know are invalid. Additionally, if time signatures are identical, both transactions may be considered invalid. However, given enough time for each transaction to reach every delegate, consensus can be established. And, delegates that often disagree with the majority may be held accountable and replaced by the stakeholders.

DAPoS functionality may thus serve to maximize parallelizable transaction throughput. DAPoS may maximize scalability of transaction throughput by minimizing delegates' codependency. Once transaction information is evenly distributed between delegates, each delegate autonomously and deterministically accepts the transaction into their chain and reports the validity of the transaction. DAPoS delegates may communicate to one another about which transactions they have received from external actors using cryptographically secure authentication systems, such as the elliptic curve digital signature algorithm.

DAPoS may thus be used to ensure that all network participants maintain an identical world state. DAPoS may use elected delegates yet operate on the gossiping of individual transactions rather than relying on the sequential distribution of blocks. Put differently, DAPoS may differentiate itself by handling individual transactions asynchronously via gossip protocol and not in lockstep. Validators in DAPoS consensus may each be responsible for their own state or chain of transactions, yet all functioning validators who receive all valid transactions can deterministically agree on the validity of all transactions and conclude on identical world states.

In an embodiment for determining which other delegate to gossip with, a delegate may be required to visit all other delegates before repeating any specific delegate. Each time a delegate has visited all other delegates at lest once, a gossip cycle is completed. Gossip cycles between delegates need not be synchronized. A delegate may wish to attempt to be as efficient as possible, wherein efficiency is defined as keeping delegate transaction state as uniform as possible.

In an embodiment wherein all delegates receive transactions in the order they are published, delegates will receive a transaction to determine if it is valid or not. If a transaction is invalid, then no action is taken and the transaction is ignored. If a transaction is valid, the delegate adds it to the end of its transaction chain and gossips the transaction with its validator peers. If a delegate receives transactions that are out of order, it is up to the validator to sort the transactions and re-evaluate the validity of transactions. By sorting and validating transactions asynchronously, the transaction throughput is decoupled from blocktimes entirely and the whole of the network can scale with the validation capabilities of the validators. In another embodiment, DAPoS may be a Byzantine fault tolerant assuming a high enough gossip redundancy for every valid transaction to reach every honest node. Because of cryptographic signatures associated with every transaction, no actor may fake the validity of a transaction. And because of the deterministic validation function being run by delegated validators, every validator may find the same world state in an isolated environment. An unreliable validator who adds invalid transactions to their chain or does not add valid transactions to their chain may deterministically reach a different world state than the other validators and should be replaced.

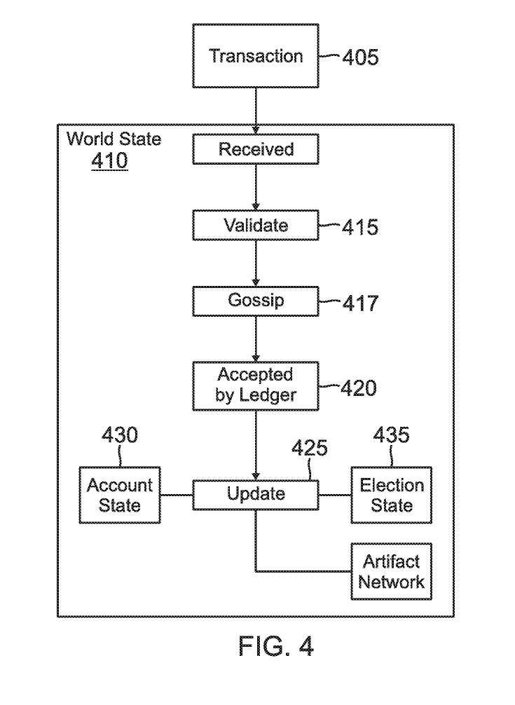

FIG. 4 is a functional flow diagram generally illustrating an embodiment of transaction states occurring in a world state. In an embodiment, a transaction 405, constructed by an external actor, is a cryptographically unmodifiable instruction to change a world state. A transaction 405 may also be defined as a request to update the system state. A transaction 405 may include many fields, and most often requires a timestamp, a transaction hash, and a set of cryptographically secure signatures. A transaction 405 may accomplish one or more of the following: instruct validators to move balance from a sender's account to a recipient's account, update the state of a smart contract, or write changes to an artifact network.

When a transaction 405 is received by a delegate in a world state 410, a transaction 405 may be considered valid 415 by a delegate if it is formatted correctly. Following validation 415, a transaction 405 may be gossiped, i.e. via DAPoS. All valid transactions may be accepted 420 into a ledger, regardless of the success of the execution of the transaction 405. A transaction 405 may be considered successful if its execution results in an update 425 to the world state 410.

Pulling apart the acceptance and execution of transactions may have at least two benefits: 1. Increased throughput for transactions that alter the asymmetric information stored in an artifact network, and 2. Transactions that are accepted but not successful may still be used to manage the bandwidth consumed by the sending account.

Smart contracts and Dapps built on the protocol platform may have their own state, with the protocol platform network comprising the states of all. Dapps built upon it. The entirety of the protocol platform's ledger may be designated a world state 410. Outside of application-specific states, the protocol platform's world state 410 may include two specific state subsets: account states 430 and election states 435.

A fundamental functionality of a ledger is to maintain a state of account balances. Account balances can be vital in the maintenance of the protocol platform network and can underlie core functionalities such as delegate elections and stake-based rate-limiting. Stakes in the network may be weighed as balance ownership of the system's currency, such as tokens, and bandwidth may be efficiently monitored and allocated by dynamic fractional reserves. Accounts may exist either under the control of an external actor or as an automated smart contract. In one embodiment, account states 430 may be comprised of the following six fields: 1. address (i.e. of an account holder or a contract creation transaction), 2. balance (i.e. of tokens), 3. bookkeeper (i.e. identification of availability to function as a delegate), 4. codehash (i.e. an account holder or smart contract's immutable code), 5. root (i.e. a hash of the root node of a Merkle Patricia tree that encodes storage contents of an account), and 6. name (i.e. an array that operates as a human-readable username to be associated with accounts controlled by external actors or a smart contract account).

An election state 435 may be defined as a supplementary state maintained natively by a protocol platform. An election state 435 may be used by a protocol platform's consensus algorithm to elect quorum of validators and determine their salary compensation. An election state 435 may have the following three properties, each of which may be voted on by stakeholders: 1. Count (a scalar value representing how many of the top voted delegates are considered officially elected), 2. Salary (a scalar value representing how many tokens each delegate's account may be credited for their work at the end of the next election cycle, and, 3. Delegates (addresses representing the ordered list of the highest-voted delegates of a current election cycle; with these addresses being considered the network's official quorum for the remainder of the election cycle).

In another embodiment, a transaction's fields may comprise a timestamp (Tₜₛ), a transaction hash (Tₕ), and a set of cryptographically secure signatures (T₈). A signature (S[D^{k}]) of a transaction may be created when a delegate receives information about a specific transaction. A signature may be a byte array that can be used to recover addresses of creating delegates. External actors may sign their transaction data and upon receipt of a transaction, delegates add their timestamped signature. Additionally, as the value of the byte array, each delegate signature may contain a timestamp of when it was created (designated as S[D^{k}]ₜₛ).

A delegate's ledger may be a record of all transactions that have been accepted by a threshold of delegates. Determining the timing of signatures is important. An initial lag threshold (Lᵢ) may be defined as the maximum amount of time that has elapsed between Tₜₛ and the first receipt by a delegate. A gossip lag threshold (L_{g}) may be defined as the maximum amount of time that is allowed between one delegate's signature and the next. The lag threshold for delegate gossip can be critical to ensure the eventual finality of a transaction. The ledger may have an ever-sliding window at its tail wherein the transactions have only been provisionally execute. This window bounds the worst-case scenario of malicious delegate collusion. The window size (w) is given by: w=Lᵢ+([2N_{D}/3]−1) L_{g}, wherein N_{D} represents the number of delegates.

In another embodiment, a transaction (T) may pass through three distinct temporary phases, relative to each delegate, without being necessarily recorded on a transaction record. A transaction may be received when it has at least one delegate signature but less than [2N_{D}/3]—within the allotted L_{g} time frame. A transaction may stay in the received state indefinitely, and it will never added to the ledger (AO. The delegate state transition function Ω updates the state δ^{k}ₜ of the delegate D^{k} after it receives a set of transactions (B={T₀, T₁, . . . }): δ^{k}ₜ₊₁→Ω (δ^{k}ₜ, B, Σ); where |B| is equal to or greater than one. E is the set of signatures and timestamps collected by each transaction of B, prior to visiting D^{k}. Σ=Ø if D^{k} receives the transaction directly from a user. A delegate may accept a transaction when it sees signatures from [2N_{D}/3] delegates within the allotted L_{g} time frame. This would happen at or before the lapse time set by Aₜ=[2N_{D}/3]×L_{g}+Lₜ. A delegate may validate a transaction once it is accepted. Validating a transaction may apply the updates associated with the transaction into the system state at time Tₜₛ. This would happen at or before Aₜ. Once a delegate recognizes a transaction as having been processed, responsibility of reporting the transaction validity to stakeholders could move on to the bookkeepers. The new state σₜ₊₁ of the ledger is given by the state transition function A as follows: σₜ₊₁→Λ(σₜ, B*), where B* is the set of validated transactions, with B*⊆B and B* does not equal 0.

In one embodiment, transactions may have the following varying properties based on their type (Tₜ) (a single byte that determines the function of the transaction): From (T_{f}) (sender's address); To (Tₜₒ) (recipient's address); Value (Tᵥ) (a scalar value equal to the total amount of tokens to be transferred from the From address to the To address); Time (Tₜₛ) (such as a RFC3339 standard time signature; determines order in the ledger); Code (T_{c}) (a virtual machine bytecode that can be executed each time a subsequent execute transaction is called with a To value that equals the Hash of the transaction); ABI (Tₐ) (an application binary interface for the smart contract being deployed; when applied to the virtual machine bytecode, the ABI defines the methods available to interact with the smart contract and their required parameters); Method (Tₘ) (an unlimited size byte array that maps to a method defined in the ABI); Params (Tₚ) (an unlimited size byte array that maps to the parameters of Method as defined in the ABI); Hash (Tₕ) (a hash of the concatenation of the Type, From, To, Value, Code, ABI, Method, Params, and Time fields, in that order; may be used as the unique identifier for all transactions; in deploy transactions, hash may also be used as the address of the deployed smart contracts); and Signature (Tₐ) (a byte array in [R∥S∥V] format of the Hash; where V is 0 or 1; R, S, and V are values used in the signature algorithm used to recover the From address and prove that the transaction was created by the owner of the associated private key).

In another embodiment, a transaction flow for a single active transaction in a system where there are no faults may comprise a total of three delegates (N_{D}=3). An external actor creates T with relevant data (including Tₜₛ) and sends it to D⁽¹⁾. D⁽¹⁾ checks to be sure that Lᵢ has not been surpassed, using its current time and Tₜₛ. If this does not pass or D⁽¹⁾ can determine that T is obviously invalid, D⁽¹⁾ would respond synchronously to the external actor that T has been declined. D⁽¹⁾ creates S[D⁽¹⁾], pushes it into a new array, and adds the array to T (formerly Tₛ). D⁽¹⁾ writes T into storage using Tₕ as the key. D⁽¹⁾ selects a delegate to visit with, in this embodiment randomly selecting D⁽²⁾. D⁽¹⁾ sends D₂ a key/value map of all the transaction signatures it knows about in storage. The key of the map is Tₙ, while the value is Tₛ. D⁽²⁾ compares each of the Tₛ lists provided with what it has in storage to determine which are the same, which D⁽²⁾ has seen but have new signatures in the provided list, and which D⁽²⁾ has never seen (For any Tₛ lists that are the same, D⁽²⁾ takes no action; for any Tₛ lists that have new signatures, D⁽²⁾ should merge its stored Tₛ list with the incoming Tₛ list, keeping only a single unique S[Dₓ] (a “set”); in the case of two or more signatures from the same delegate with different S[D^{k}ₓ]ts values, all signatures from that delegate should be removed from the stored. Tₛ list; for any Tₛ lists which have never been seen, D⁽²⁾ should include the Tₕ in a response to D⁽²⁾). D⁽¹⁾ receives the response of Tₕ list that D₂ has never seen and sends another message to D⁽²⁾ containing the T for each of those Tₕ. D⁽²⁾ receives the message and performs the following for each T: D₂ creates S[D⁽²⁾], appending it to the end of Tₛ; D⁽²⁾ writes T into storage, using Tₕ as the key; D⁽²⁾ examines the resulting length of the array (Tₛ·ln) and attempts to determine if it is long enough to qualify for having been seen by at least 66% of the delegates (Tₛ·ln is equal to or greater than [2N_{D}/3]; if the array is not long enough, the thread terminates; if the array is long enough, D⁽²⁾ will confirm that the time between the first signature and Tₜ, (Tₛ[0]ₜₛ) is equal to or less than Lᵢ; D⁽²⁾ will then work upwards through the Tₛ array, checking that each signature's time differential (Tₛ[x+1]ts−Tₛ[x]ts) is equal to or less than L_{g}; if any faults are found, T will be rejected and the thread will terminate; when no faults are found in [2N_{D}/3] of the differentials, D⁽²⁾ accepts T and removes it from storage; D⁽²⁾ will add T into a list of accepted transactions (Aᵣ) and the thread terminates. Once all threads for the message are complete, D⁽²⁾ will broadcast Aᵣ to every other delegate, which in our example are D⁽¹⁾ and D⁽³⁾. D⁽¹⁾ and D⁽³⁾ each receive the broadcast and, independently, for each T included, perform the following: D^{(k)} seeks to accept T; D^{(k)} will also check the time between when the final signature was added (Tₛ[(Tₛ·ln)ᵣₛ) and the time when the broadcast (bₜₛ) was received (T₈[(Tₛ·ln)ₜₛ−bᵣₛ) to ensure that its less than L_{g}; if D^{(k)} also accepts T, then D^{(k)} removes T from its storage and the thread terminates; if D^{(k)} fails to accept T (and/or the final lag check fails to pass), then D^{(k)} leaves T in storage (to be included in future visits with other delegates). Finally, D⁽²⁾ selects a delegate to visit.

In another embodiment, a delegate (D^{k}, where k denotes a nonlinear identifier of a specific delegate node) may be an elected computer system that is responsible for verifying T. A Delegate may be required to have an accurate clock as well as an efficient key-value storage mechanism. The set of delegates in the system may be defined as D, and have cardinality |D|=N_{D}, with the constraint N_{D} being equal to or greater than three. In such a system, bookkeepers may be responsible for comparing delegate ledgers, help delegates distribute information to stakeholders efficiently, and hold delegates accountable for their responsibilities. Bookkeepers may be responsible for executing transactions accepted into the ledger by delegates. This makes delegates themselves a subset of the bookkeepers. The bookkeepers may also record the states of the delegates, such that unresponsive delegates can be reported and replaced quickly; all while providing an audit trail of accountability in case of a delegate fork. Bookkeepers can also help reduce administrative stress from the delegates, such as syncing the chain.

Anyone may elect to run a bookkeeper node to help the network. And, anyone may be a bookkeeper; with the system's security increasing as the amount of bookkeepers increase. Bookkeepers may thus be thought of as independent network scanners that end users can query. Delegates may send their validated transactions to bookkeepers, who in turn make relative delegate data available for stakeholders. Stakeholders may evaluate the performance of the delegates and assign their voting power accordingly. If the bookkeepers continually report a delegate's bad behavior, it is the responsibility of stakeholders to reassign their votes to another potential delegate. In such an embodiment, an external actor may be a piece of software that an end user, such as an individual, interacts with. An external actor should have a reasonably accurate clock, and submits system-state update requests to delegates in the form of transactions.

In an embodiment wherein the protocol platform ensures everyone using the protocol platform has a say in its governance, a delegated quorum of validator nodes may be elected based on stake-based voting. Stakeholders may be entitled to one vote per full token, rounded down. Stakeholders may cast their votes as transactions of an election type. Votes are submitted to the election as a percentage of account balance. All stakeholders may vote on three properties of the election state: the number of delegates, the ordered list of preferred delegates, and the salary of the elected delegates. Delegate election cycles may occur frequently, such as on an hourly basis. The number of delegates and the delegate salary may be determined as the median of submitted votes. Both values may have a maximum rate of change. Whereas a delegate count may have a minimum quantity, the salary may not have a minimum required amount. The maximum rate of change however, may be limited, such as a maximum of 0.1% each election cycle. Once the number of delegates has been determined, the protocol platform may implement a single transferable vote method of election. In one example, the protocol platform may use Droop Quota with a Meek Rule method of counting for determining which nodes will become delegates. The delegate count sized ranked list of delegate ballots are multiplied by the voters' balance, so the results are calculated as one ballot per share. The Droop Quota is then used to calculate the number of votes a delegate candidate needs to win a position. The first choice votes are tallied, and if a candidate has enough votes to secure a position they are considered elected as the top choice delegate. Votes for the lowest ranked candidates are then reallocated to the voters' second choice candidates. Candidates with enough votes to meet the Droop Quota are considered elected. The cycle of vote reallocation repeats until enough candidates have enough votes to be considered elected.

In one embodiment, the protocol platform may not incorporate transaction fees, incorporating a stake-based rate limiting. Stake in the protocol platform may be weighed as balance ownership to the system's token, and bandwidth may be efficiently monitored and allocated by dynamic fractional reserves.

In another embodiment, hertz may be defined as a unit of measurement for bandwidth consumed by a transaction. hertz-per-share price may be based on a maximum validation bandwidth of the delegates. As an alternative to price fluctuation during times of high network traffic, the protocol platform may implement a variable time-to-reimbursement. This may enable that, under most conditions, possession of tokens by a user entitles that individual user to some number of transactions. In order to incentivize users to wait to send transactions until the network usage is under-capacity, time-to-reimbursement may be quicker when network-wide traffic is low. Conversely, the time-to-reimbursement may be greater when the network-wide traffic is high. Regardless, these dynamic fractional reserves optimize to fully utilize network bandwidth at all times. Because each transaction may be a dramatically different amount of work process, network traffic may be measured by the amount of hertz used over time. In an embodiment where the current days traffic rises higher than the weekly average, the time-to-reimbursement may rise to mitigate traffic spikes. The base price of hertz may exist to counter volatility in the token price and is set by the delegates. Each delegate may get one vote on the base price, with the final price being determined by taking the median of the delegates' votes rounded down. Delegates who keep the hertz price high to reduce their own workload may be voted out by stakeholders and replaced with a delegate whose base hertz price matches the criteria set by stakeholders. Before a valid transaction is executed by the bookkeepers, the sending account's remaining hertz may be calculated by subtracting the outstanding hertz spent by the account from the account's balance. If the sending account has spent more in hertz than the available balance in the account, the transaction is considered invalid, and is not gossiped. If in the execution of a transaction, the amount of tokens spent on bandwidth exceeds the amount remaining in the accounts balance, an error may be returned. Delegates may record the valid transaction as unsuccessful, and the remaining balance spent on bandwidth is considered spent. In the case that a transaction's Tᵥ>0, or a transaction is a token transfer type, the transaction value Tᵥ must be greater than or equal to the bandwidth cost of that transaction. The hertz cost may be considered spent by the Tₜₒ account to prevent the repeated transferring of the same tokens.

In an embodiment of capturing the value of the existing Dapp ecosystem, the protocol platform may be designed to be backwards compatible with a third party virtual machine, such as the ethereum virtual machine. Third party virtual machine bytecode may thus be acceptable in the protocol platform's virtual machine even though the protocol platform's virtual machine bytecode may not necessarily be acceptable by the third party virtual machine. The protocol platform's virtual machine may support third party interfaces and add a new set on the artifact network to refer to operations.

In embodiments of updating artifacts in the artifact network, challenges may be presented where data is distributed across any number of farmers with any quantity of available storage capacity. Farmers of an artifact may not have the capacity to accept a large update to the artifact being stored, nor may updates lower the size of an artifact. The artifact network may consider all updates to be additions in the form of artifact deltas (A). A delta may define the exact differences between an artifact (A) and its updated version (A′). An artifact may have any number of deltas, which may be required to be ordered. Deltas may have no size limitation. An artifact may be considered updated when it has been combined with all of its deltas, such as in: A=U(A, Δ₁, Δ₂, . . . Aₙ), where n is the number of deltas associated with the artifact and U is the deterministic artifact update function. The distribution access to deltas may be defined in the artifacts initialization smart contract.

In another embodiment, the protocol platform's virtual machine may support the interface of every function defined in a third party virtual machine. Some modifications may be made that provide alternative but compatible functionality. Examples comprise: 0x41, Coinbase (the dispatch protocol uses a delegated consensus mechanism that does not have block beneficiaries; instead, this value is replaced with the hash of the ordered list of delegate address); 0x44, Difficulty (block difficulty is 0); 0x45, Gaslimit (instead, returns the amount of hertz consumed at the given time interval and many more functions are updates with minimal changes, such as mapping ethereum's gas to the protocol platform's bandwidth measurement, hertz); 0xd0, Artifact (returns the Merkle hash of the accounts artifact); 0xd1, Artifactsize (returns the size in bytes of the accounts artifact); 0xd2, Artifactstructure (returns 0 for binary large object artifacts and 1 for structured artifacts); 0xd3, Artifactencrypt (defined at time of account initialization, returns 0 for unencrypted artifacts and 1 for encrypted artifacts); 0xd4, Readartifact (formally declares the address of a new downloader on a ledger); 0xd5, Updateartifact (saves the hash of a new artifact delta to a ledger); and 0xd6, Analytics (saves the requested step of an analytic query to a ledger for farmers to execute against the accounts artifact and deltas).

The protocol platform may be supported by one or more languages. In one embodiment, the protocol platform may be supported by Solidity. Solidity and a sole compiler may compile down to a third party virtual machine bytecode that utilizes a majority of the functionality of the protocol platform's virtual machine. The protocol platform may also incorporate a compiler for novel high-level language that includes the base functionality of Solidity and additional artifact-related functionality. The protocol platform may also incorporate a virtual machine bytecode backend for a third party compiler. A third party compiler may support a wide variety of front-end languages, such as Fortran and Python. The protocol platform's extension of supported smart-contract languages may enable a wide range of developers from various backgrounds and industries to develop corresponding Dapps on the protocol platform's virtual machine.

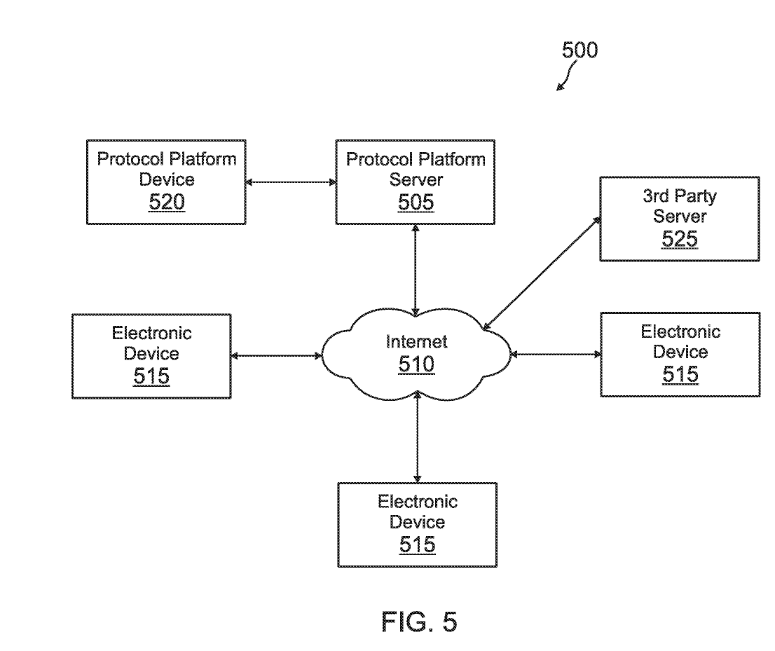

FIG. 5 is a functional block diagram generally illustrating an embodiment of a network system 500 of a blockchain-supported programmable information management and data distribution system (“protocol platform”). The network system 500 may comprise a protocol platform server 505 that may be accessible over a local area network or a wide area network 510, such as the Internet. The protocol platform server 505 may be accessible through a network 510 by a plurality of electronic devices 515 and one or more third party servers 525. The protocol platform device 520 may access the protocol platform server 505 directly, or alternatively, through a network 510.

In a preferred embodiment, the protocol platform server 505 is remotely accessible by a plurality of electronic devices 515, such as laptops, tablets, desktops, smartphones, and other computing devices that are able to access a network 510 where the protocol platform server 505 resides. In other embodiments, an individual electronic device 515 may take the form of computer software and hardware deployed in a local computing environment or perhaps in a remote-hosted computing environment. In an embodiment, an electronic device 515 connects with the protocol platform server 505 to create, access, and view transactions occurring in the protocol platform. Electronic devices 515 may also host their own protocol platform.

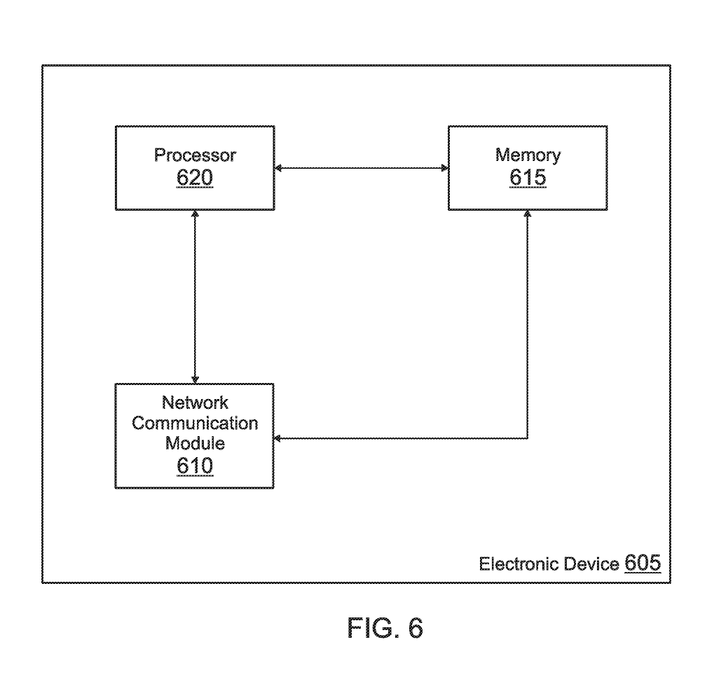

FIG. 6 is a functional block diagram generally illustrating an embodiment of an electronic device system of a blockchain-supported programmable information management and data distribution system. The electronic device 605 may comprise a network communications module 610, which allows for connection to a protocol platform server or other servers or networks. The electronic device 605 may further comprise a memory 615, and a processor 620. The electronic device 605 is not limited to any particular configuration or system.

Other embodiments may include combinations and sub-combinations of features described or shown in the several figures, including for example, embodiments that are equivalent to providing or applying a feature in a different order than in a described embodiment, extracting an individual feature from one embodiment and inserting such feature into another embodiment; removing one or more features from an embodiment; or both removing one or more features from an embodiment and adding one or more features extracted from one or more other embodiments, while providing the advantages of the features incorporated in such combinations and sub-combinations. As used in this paragraph, “feature” or “features” can refer to structures and/or functions of an apparatus, article of manufacture or system, and/or the steps, acts, or modalities of a method.

References throughout this specification to “one embodiment,” “an embodiment,” “an example embodiment,” etc., indicate that the embodiment described may include a particular feature, structure, or characteristic, but every embodiment may not necessarily include that particular feature, structure, or characteristic. Moreover, such phrases are not necessarily referring to the same embodiment. Further, when a particular feature, structure, or characteristic is described in connection with one embodiment, it will be within the knowledge of one skilled in the art to affect such feature, structure, or characteristic in connection with other embodiments whether or not explicitly described.

Unless the context clearly indicates otherwise (1) the word “and” indicates the conjunctive; (2) the word “or” indicates the disjunctive; (3) when the article is phrased in the disjunctive, followed by the words “or both,” both the conjunctive and disjunctive are intended; and (4) the word “and” or “or” between the last two items in a series applies to the entire series.

Where a group is expressed using the term “one or more” followed by a plural noun, any further use of that noun to refer to one or more members of the group shall indicate both the singular and the plural form of the noun. For example, a group expressed as having “one or more members” followed by a reference to “the members” of the group shall mean “the member” if there is only one member of the group.

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

What is claimed is:

1. A blockchain-supported programmable information management and data distribution system, the system comprising a processor, memory accessible by the processor, and instructions stored in the memory and executable by the processor to perform:
establishing custody of at least one artifact;
generating an update to the system, wherein the update to the system is generated by:
generating at least one transaction upon the establishing custody of at least one artifact;
validating the at least one transaction;
accepting the at least one transaction into a ledger; and
executing the at least one transaction;
transmitting to a virtual machine confirmation of an update of the at least one artifact; and
transmitting to a virtual machine confirmation of the executing the at least one transaction.

2. The system of claim 1, wherein the processor is further configured to perform:
transmitting the update of the at least one artifact to an artifact network, wherein the artifact network stores the at least one artifact; and
transmitting to the ledger a state of the update of the at least one artifact.

3. The system of claim 1, wherein the processor is further configured to perform:
transmitting at least one smart contract to the virtual machine; and
publishing the at least one smart contract to the ledger.

4. The system of claim 1, wherein the at least one artifact comprises a data object.

5. The system of claim 1, comprising one or more actors, wherein an actor comprises at least one of: a stakeholder, an uploader, a downloader, a farmer, or combinations thereof.

6. The system of claim 5, wherein actions by the one or more actors comprises at least one of: generating one or more updates to the ledger, generating an upload of at least one artifact, receiving the upload of at least one artifact, downloading the at least one artifact, delivering the upload of at least one artifact, or combinations thereof.

7. The system of claim 5, wherein the one or more actors comprises a distributed hash table.

8. The system of claim 1, wherein the generating an update to the system comprises an account state; wherein the account state comprises a state of account balances.

9. The system of claim 1, wherein the generating an update to the system comprises an election state; wherein the election state elects a quorum of validators; and wherein the election state comprises stakeholders voting on at least one of: a count property, a salary property, a delegates property, or combinations thereof.

10. The system of claim 1, further comprising a storage orderbook, wherein the storage orderbook comprises agreements between two or more of the actors.

11. A method for a blockchain-supported programmable information management and data distribution system, comprising:
establishing custody of at least one artifact;
generating an update to the system, wherein the update to the system is generated by:
generating at least one transaction upon the establishing custody of at least one artifact;
validating the at least one transaction;
accepting the at least one transaction into a ledger; and
executing the at least one transaction;
transmitting to a virtual machine confirmation of an update of the at least one artifact; and
transmitting to a virtual machine confirmation of the executing the at least one transaction.

12. The method of claim 11, further comprising:
transmitting the update of the at least one artifact to an artifact network, wherein the artifact network stores the at least one artifact; and
transmitting to the ledger a state of the update of the at least one artifact.

13. The method of claim 11, further comprising:
transmitting at least one smart contract to the virtual machine; and
publishing the at least one smart contract to the ledger.

14. The method of claim 11, wherein the at least one artifact comprises a data object.

15. The method of claim 11, comprising one or more actors, wherein an actor comprises at least one of: a stakeholder, an uploader, a downloader, a farmer, or combinations thereof.

16. The method of claim 15, wherein actions by the one or more actors comprises at least one of: generating one or more updates to the ledger, generating an upload of at least one artifact, receiving the upload of at least one artifact, downloading the at least one artifact, delivering the upload of at least one artifact, or combinations thereof.

17. The method of claim 15, wherein the one or more actors comprises a distributed hash table.

18. The method of claim 11, wherein the generating an update to the system comprises an account state; wherein the account state comprises a state of account balances.

19. The method of claim 11, wherein the generating an update to the system comprises an election state; wherein the election state elects a quorum of validators; and wherein the election state comprises stakeholders voting on at least one of: a count property, a salary property, a delegates property, or combinations thereof.

20. The method of claim 11, further comprising a storage orderbook, wherein the storage orderbook comprises agreements between two or more of the actors
